(19) United States
(12) Patent Application Publication
(10) Pub. No.: US 2026/0187922 A1
(43) Pub. Date: Jul. 2, 2026

(54) FEED-FORWARD STRUCTURE-FROM-MOTION VIA LATENT GLOBAL ALIGNMENT

(71) Applicant: NVIDIA Corporation, Santa Clara, CA (US)

(72) Inventors: Sven Harald Adolf Elflein, Toronto (CA); Sergio Da Silva Agostinho, Freising (DE); Qunjie Zhou, München (DE); Laura Leal-Taixe, Florence (IT)

(21) Appl. No.: 19/433,236

(22) Filed: Dec. 26, 2025

Related U.S. Application Data
(60) Provisional application No. 63/739,485, filed on Dec. 27, 2024.

(51) Int. Cl. G06T 17/05; G06N 3/09; G06V 10/426

(52) U.S. Cl. CPC G06T 17/05; G06N 3/09; G06V 10/426

(57) ABSTRACT

Systems and methods for performing three-dimensional (3D) scene reconstruction based on a set of images. According to one or more embodiments, neural network architectures and machine learning techniques are provided for performing global alignment in latent space to share context information across the input images and reconstructing selective image pairs according to relevant correspondences between images, thereby enabling robust, accurate, and efficient global alignment for a variety of computer vision applications, e.g., 3D reconstruction.

### CLAIM OF PRIORITY

This application claims the benefit of U.S. Provisional Application No. 63/739,485, filed Dec. 27, 2024, the entire contents of which are incorporated herein by reference.

### BACKGROUND

Structure-from-Motion (SfM) is the task of jointly recovering camera poses and reconstructing three-dimensional (3D) scene structure from a set of unconstrained images. Solving this long standing problem is essential to many computer vision applications, including novel view synthesis via neural radiance fields (NeRFs) and three dimensional Gaussian Splats (3DGS), multi-view stereo (MVS) reconstruction, and visual localization. Traditional SfM methods generally follow two main approaches: incremental and global SfM. Both paradigms rely on key components such as feature detection and matching for correspondence search, 3D triangulation to reconstruct geometry from 2D correspondences, and joint optimization of camera poses and scene geometry through bundle adjustment.

Certain learning-based methods use optimization-based global alignment, which first compute stereo reconstruction exhaustively for all image pairs and then obtain globally aligned pointmaps (point cloud maps) for all cameras through joint optimization of pairwise rigid transformations and local pointmaps. This, however, comes at the cost of slow runtime and extensive memory footprint even for moderately-sized image collections.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1A illustrates a Structure-from-Motion (SfM) system, in accordance with one or more embodiments.

FIG. 1B illustrates a system architecture for an SfM system for generating, based on a set of input images, a globally-aligned 3D pointmap, in accordance with one or more embodiments.

FIG. 1C illustrates an example network architecture of a latent global alignment block for an SfM system, in accordance with one or more embodiments.

FIG. 2 illustrates a flowchart of a method for training a neural network model to generate, based on a set of input images, a globally-aligned 3D pointmap, in accordance with one or more embodiments.

FIG. 3 illustrates a flowchart of a method for generating, based on a set of input images, a globally-aligned 3D pointmap in accordance with one or more embodiments.

FIG. 4 illustrates an example parallel processing unit (“PPU”), suitable for use in implementing one or more embodiments.

FIG. 5A illustrates a processing system, implemented using the PPU of FIG. 4, suitable for use in implementing one or more embodiments.

FIG. 5B illustrates an example system in which various architectures and/or functionality may be implemented, according to one or more embodiments.

FIG. 5C illustrates an example system suitable for training and utilizing a machine learning model, according to one or more embodiments.

FIG. 6 illustrates an example streaming system, suitable for use in implementing one or more embodiments.

### DETAILED DESCRIPTION

Systems and methods are disclosed that relate to Structure-from-Motion (SfM), and in particular, to efficient large-scale SfM from unconstrained image collections. Systems and methods are disclosed that utilize neural network architectures and machine learning techniques to accurately perform 3D reconstruction tasks while reducing runtime.

In one or more embodiments, a feed-forward, end-to-end learnable framework for SfM is provided that incorporates a scalable attention mechanism between image encoding and three-dimensional (3D) reconstruction stages. The scalable attention mechanism exploits multi-view information across all images to facilitate reconstruction of globally consistent pairwise pointmaps. In at least one embodiment, the feed-forward, end-to-end learnable framework for SfM additionally incorporates an intelligent graph construction mechanism. The intelligent graph construction mechanism provides a scene graph that enables irrelevant image pairs to be filtered prior to downstream computation, thereby eliminating the computational bottleneck inherent to exhaustive decoding of 3D pointmaps for all possible image pairs. As a result, the feed-forward, end-to-end learnable framework delivers accurate 3D reconstructions and camera poses with reduced runtime as compared to prior techniques.

A system is provided, which includes one or more processors to perform three-dimensional (3D) scene reconstruction using one or more neural networks, and one or more memories to store parameters corresponding to the one or more neural networks. The one or more processors receive a plurality of input images, generate, based on the plurality of input images, a set of image tokens, process, via an alignment network, the set of image tokens to generate a set of aligned image tokens, generate a scene graph representing relationships between the plurality of input images, the scene graph including one or more image connections, decode, based on the one or more image connections, subsets of the aligned image tokens to produce a plurality of pairwise 3D pointmaps corresponding to input image pairs, and generate, based on the plurality of pairwise pointmaps and the scene graph, a plurality of 3D pointmaps corresponding to the plurality of input images.

According to an embodiment of the system, the one or more processors further obtain a set of global tokens, each global taken representing global information associated with a subset of image tokens corresponding to an input image of the plurality of input images. Processing, via the alignment network, the set of image tokens to generate the set of aligned image tokens performed using the set of global tokens.

According to an embodiment of the system, the one or more processors further update the set of global tokens corresponding to the plurality of input images, and update, based on the set of updated global tokens, the set of image tokens.

According to an embodiment of the system, the alignment network includes one or more latent global alignment blocks. A given latent global alignment block is to receive the set of image tokens and the set of global tokens, obtain the set of updated global tokens by applying self-attention to the set of input global tokens, and obtain the set of updated image tokens by updating each subset of image tokens corresponding to an input image using the set of updated global tokens through cross-attention.

According to an embodiment of the system, the one or more latent global alignment blocks include a first latent global alignment block and a second latent global alignment block. The set of global tokens fed to the first latent global alignment block are initialized based on the set of image tokens produced by an encoder. The set of global tokens fed to the second latent global alignment block are the set of updated global tokens output from the first latent global alignment block.

According to an embodiment of the system, each pairwise 3D pointmap of the plurality of pairwise 3D pointmaps is represented in a frame coordinate system corresponding to one frame of the respective input image pair.

According to an embodiment of the system, each image connection in the scene graph corresponds to an image pair from the plurality of input images. At least one embodiment also includes decoding, based on the one or more image connections, the subsets of the aligned image tokens to produce the plurality of pairwise 3D pointmaps corresponding to the input image pairs is performed by traversing the one or more image connections in the scene graph.

According to an embodiment of the system, the scene graph is generated by maximizing pairwise image similarities.

According to an embodiment of the system, the scene graph is represented by a shortest-path tree (SPT) including a plurality of nodes and one or more edges. Each node represents an input image of the plurality of input images, and each edge connects a pair of nodes.

According to an embodiment of the system, training the one or more neural networks includes updating learnable parameters in the alignment network and updating learnable parameters in a decoder for decoding the subsets of the aligned image tokens to produce the plurality of pairwise 3D pointmaps corresponding to input image pairs. Training the one or more neural networks utilizes supervisions for pairwise local pointmaps and globally aligned pointmaps.

According to an embodiment of the system, the supervisions for pairwise local pointmaps and globally aligned pointmaps are performed using ground-truth pointmaps, corresponding valid pixels, and ground-truth camera poses.

A method is provided for performing three-dimensional (3D) scene reconstruction, which includes: receiving a plurality of input images, generating, based on the plurality of input images, a set of image tokens, processing, via an alignment network, the set of image tokens to generate a set of aligned image tokens, generating a scene graph representing relationships between the plurality of input images, the scene graph including one or more image connections, decoding, based on the one or more image connections, subsets of the aligned image tokens to produce a plurality of pairwise 3D pointmaps corresponding to input image pairs, and generating, based on the plurality of pairwise pointmaps and the scene graph, a plurality of 3D pointmaps corresponding to the plurality of input images.

According to an embodiment of the method, the method is performed by at least one of: a system for performing simulation operations, a system for performing simulation operations to test or validate autonomous machine applications, a system for performing digital twin operations, a system for performing light transport simulation, a system for rendering graphical output, a system for performing deep learning operations, a system for performing generative operations using a large language model (LLM), a language reasoning model (LRM) or a vision language model (VLM), a system for performing generative operations using a multi-modal language model, a system implemented using an edge device, a system for generating or presenting extended reality content (e.g., virtual reality (VR) content, augmented reality (AR) content, or mixed reality (MR) content), a system incorporating one or more Virtual Machines (VMs), a system implemented at least partially in a data center, a system for performing hardware testing using simulation, a system for synthetic data generation, a collaborative content creation platform for 3D assets, a system implemented at least partially using cloud computing resources, a system using or deploying one or more inference microservices, or a system that incorporates one or more machine learning models deployed in a service or microservice along with an OS-level virtualization package.

According to an embodiment of the method, the method also includes: obtaining a set of global tokens, each global taken representing global information associated with a subset of image tokens corresponding to an input image of the plurality of input images. The method also includes processing, via the alignment network, the set of image tokens to generate the set of aligned image tokens is using the set of global tokens.

According to an embodiment of the method, the method also includes: updating the set of global tokens corresponding to the plurality of input images, and updating, based on the set of updated global tokens, the set of image tokens.

According to an embodiment of the method, the alignment network includes one or more latent global alignment blocks. The method also includes: receiving, a given latent global alignment block, the set of image tokens and the set of global tokens; obtaining, by given latent global alignment block, the set of updated global tokens by applying self-attention to the set of input global tokens; and obtaining, by given latent global alignment block, the set of updated image tokens by updating each subset of image tokens corresponding to an input image using the set of updated global tokens through cross-attention.

According to an embodiment of the method, the one or more latent global alignment blocks include a first latent global alignment block and a second latent global alignment block. The set of global tokens fed to the first latent global alignment block are initialized based on the set of image tokens produced by an encoder. The set of global tokens fed to the second latent global alignment block are the set of updated global tokens output from the first latent global alignment block.

According to an embodiment of the method, each pairwise 3D pointmap of the plurality of pairwise 3D pointmaps is represented in a frame coordinate system corresponding to one frame of the respective input image pair. Each image connection in the scene graph corresponds to an image pair from the plurality of input images. Decoding, based on the one or more image connections, the subsets of the aligned image tokens to produce the plurality of pairwise 3D pointmaps corresponding to the input image pairs is performed by traversing the one or more image connections in the scene graph.

One or more processors are provided that include circuitry to implement an application programming interface (API), which in response to an API call received through the API, one or more operations including: an operation to receive a plurality of input images; an operation to generate a set of image tokens based on the plurality of input images; an operation to process, via an alignment network, the set of image tokens to generate a set of aligned image tokens; an operation to generate a scene graph representing one or more image connections between the plurality of input images; an operation to decode, based on the one or more image connections, subsets of the aligned image tokens to produce a plurality of pairwise 3D pointmaps corresponding to input image pairs; and an operation to generate, based on the plurality of pairwise pointmaps and the scene graph, a plurality of 3D pointmaps corresponding to the plurality of input images. According to an embodiment, the one or more operations further include an operation to obtain a set of global tokens, each global taken representing global information associated with a subset of image tokens corresponding to an input image of the plurality of input images, and the operation to process, via the alignment network, the set of image tokens to generate the set of aligned image tokens comprises an operation to process the set of global tokens.

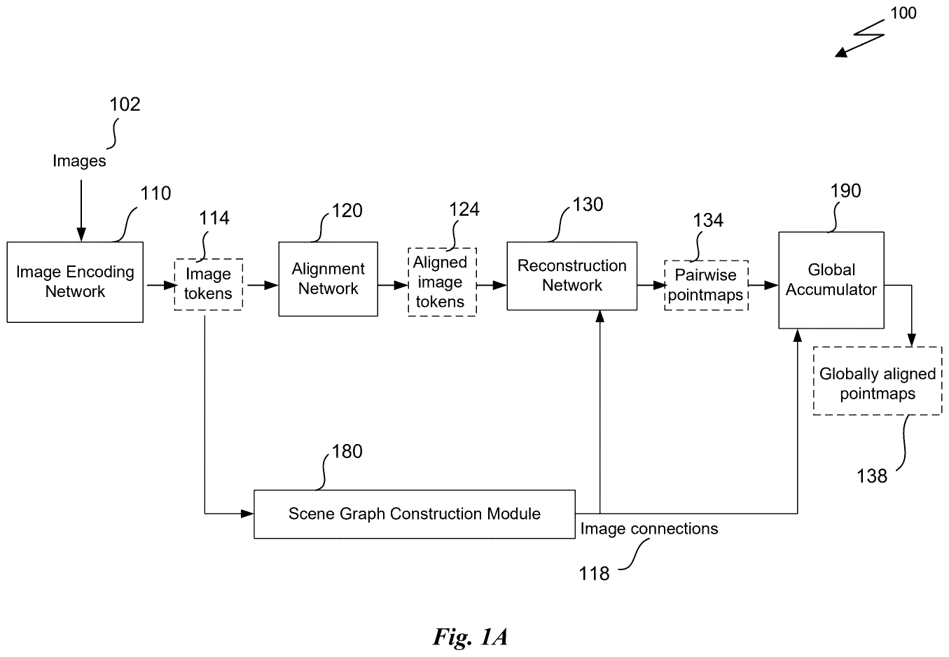

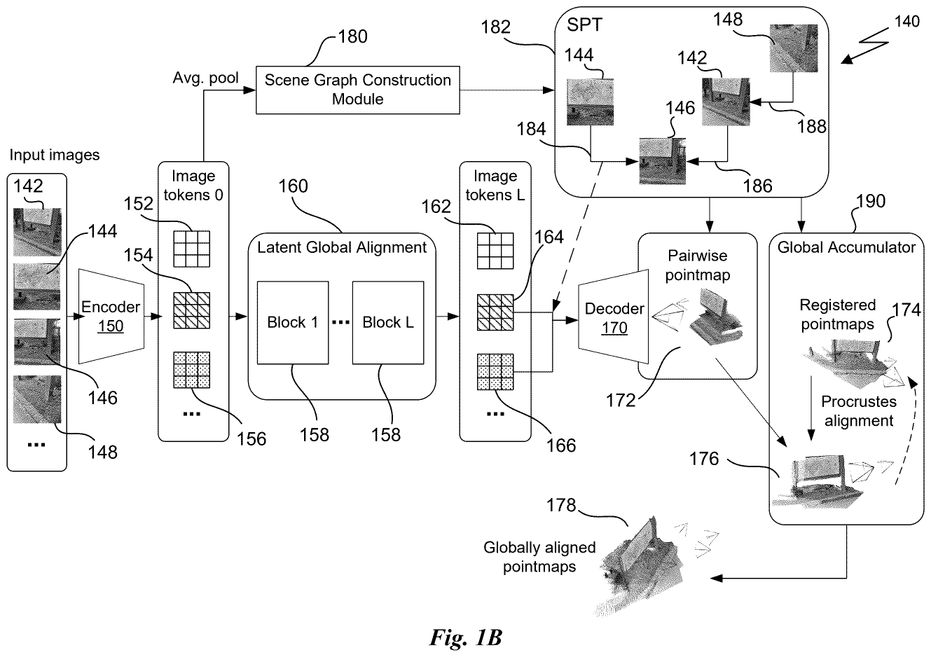

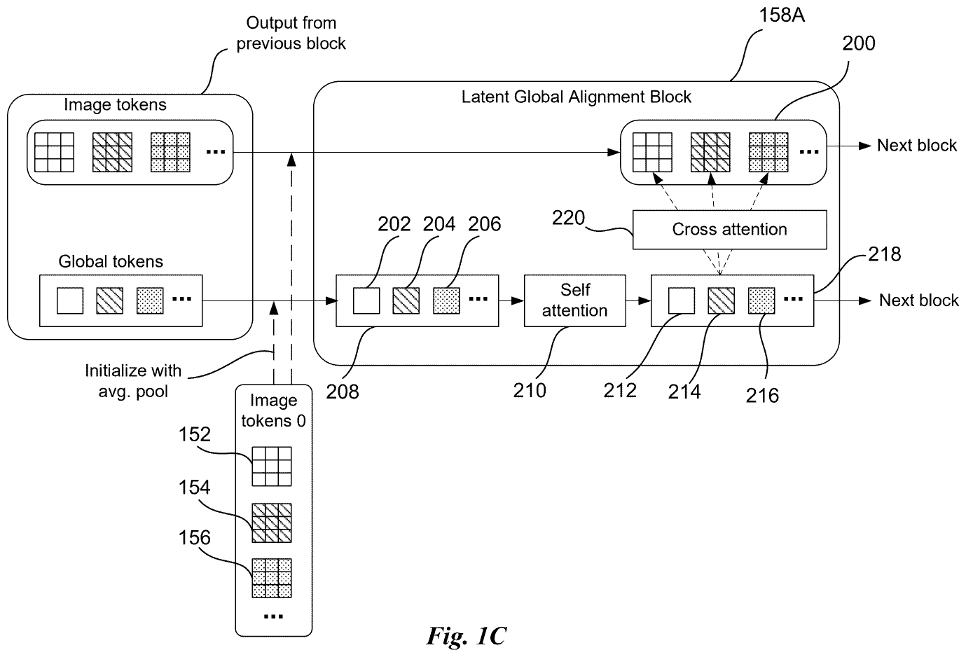

FIG. 1A illustrates an SfM system 100, in accordance with one or more embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories.

The system 100 includes an image encoding network 110, an alignment network 120, a reconstruction network 130, a global accumulator 190, and a scene graph construction module 180.

The system 100 receives a set images 102 as input and produces globally-aligned, 3D pointmaps 138 as output. In various embodiments, the set of images 102 is a set of ordered images or a set of unordered images. Unordered images refer to images with little or no information pertaining to their temporal sequence or spatial arrangement. In one or more embodiments, the output includes a set of globally aligned individual 3D pointmaps, where each input image corresponds to a globally aligned pointmap. The globally aligned individual 3D pointmaps can be merged depending on the downstream applications.

The image encoding network 110 encodes the input images 102 to produce image tokens 114 for processing in a latent space. In certain embodiments, the image encoding network 110 employs an encoder (or a plurality of encoders) to perform the encoding. The encoding may be performed sequentially, in parallel, or using a hybrid approach. In certain embodiments, the encoder (or the plurality of encoders) is a pre-trained or readily available off-the-shelf encoder model.

In certain embodiments, each input image is first divided into patches, with each patch encoded into an image token. Accordingly, the image encoding network 110 produces a set of image tokens 114 representing the patches of all input images 102.

The alignment network 120 receives the set of image tokens 114 as input and produces a set of aligned image tokens 124 as output. In certain embodiments, the alignment network 120 includes one or more latent global alignment blocks. For example, eight latent global alignment blocks may be sequentially connected and employed in the alignment network 120. Each latent global alignment block receives a set of input tokens (e.g., the set of image tokens 114 in the case of the first alignment block or a set of updated image tokens output by a preceding latent global alignment block in the case of subsequent alignment blocks) and performs implicit global alignment in a latent space via an attention mechanism to produce a set of updated image tokens. Each updated image token includes, as compared to a corresponding input token, enhanced contextual information, capturing multi-view constraints across the set of images 102. Each latent global alignment block progressively enhances the set of input tokens it receives to capture global context and interdependencies across all input images 102. In at least one embodiment, the alignment network 120 has the same architecture as the latent global alignment network 160 of FIG. 1B. Finally, the global alignment network 120 outputs the set of aligned image tokens 124 for downstream processing by the reconstruction network 130.

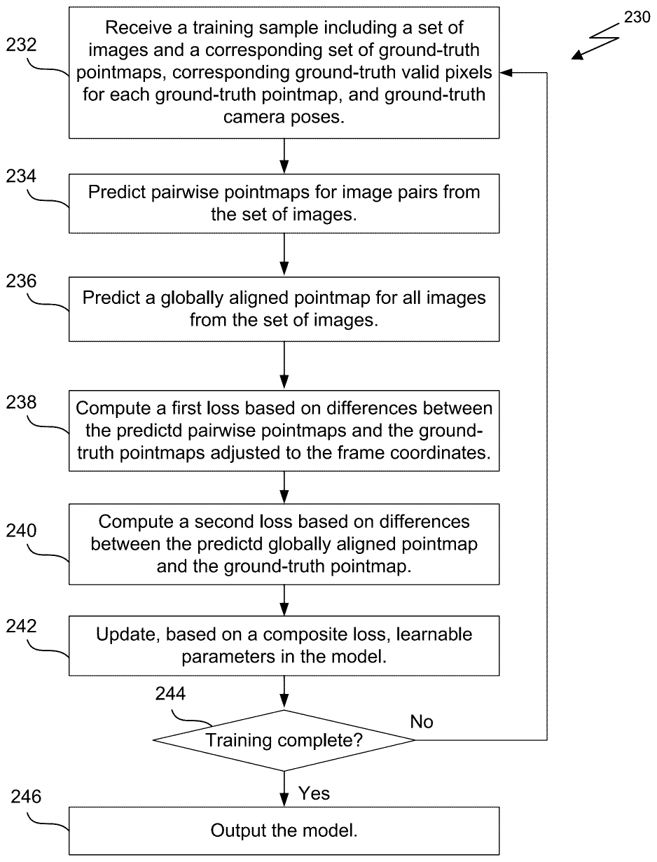

The scene graph construction module 180 receives the set of image tokens 114 as input and produces a scene graph as output. The scene graph includes image connections 118 between individual images included in the set of images 102. In certain embodiments, the scene graph includes a node for each image in the set of images 102 and an edge for each image connection of a set of image connections 118. In at least one embodiment, the number of image connections 118 is one less (i.e., N−1) than the number of images in the set of images 102. In certain embodiments, the scene graph construction module 180 determines the set of image connections 118 by computing pairwise similarities (e.g., a Euclidean distance, a cosine distance, a cosine similarity, etc.) for all image pairs in the set of images 102. Each pairwise similarity provides a measure of relative overlap or connectivity of an image pair within the scene. In various embodiments, the scene graph is provided as a shortest-path tree (SPT), a spanning tree, a weighted graph, or an adjacency matrix. The scene graph construction module 180 provides the determined image connections 118 to the reconstruction network 130, thereby guiding the reconstruction network 130 to process selective subsets of the aligned image tokens 124 that correspond to specific pairs of input images. This way, the overall computational burden is reduced. In certain embodiments, the reconstruction network 130 employs a decoder to perform pairwise decoding on the aligned image tokens 124. In other embodiments, a plurality of decoders are employed to perform pairwise decoding in parallel. The decoder may be obtained through training (e.g., by performing the method 220 illustrated in FIG. 2). The plurality of decoders may be instances of the decoder 132 instantiated to perform parallel computation.

The reconstruction network 130 receives, as input, the aligned image tokens 124 and the set of image connections 118 and reconstructs 3D representations (i.e., pairwise pointmaps) of the scene captured by the set of images 102. Each pairwise pointmap corresponds to a 3D coordinate frame (e.g., the coordinate frame of one image of an image pair corresponding to an image connection in the set of image connections 118). By repeating this process while traversing the image pairs indicated by the set of image connections 118, the reconstruction network 130 generates pairwise pointmaps for all image connections in the set of image connections 118, thereby generating a set of pairwise pointmaps 134. In various embodiments, individual pairwise pointmaps in the set of pairwise pointmaps 134 may be associated with the same or different coordinate frames). In certain embodiments, the reconstruction network 130 is conditioned on all input images 102 during generation of each pairwise pointmap in the set of pairwise pointmaps 134.

In certain embodiments, the reconstruction network 130 additionally produces, as output, camera properties (e.g., camera intrinsics and extrinsics) corresponding to each image in the set of images 102. For example, the global camera poses are computed for each image using the predicted pointmaps 134. In at least one embodiment, each 3D point in the predicted pointmap is associated with a confidence score. Prior to computing the camera pose, 3D points with confidence scores below a predefined confidence threshold may be filtered out. The confidence threshold can be adjusted based on specific requirements; for instance, increasing the threshold may reduce the registration rate while improving pose accuracy in certain situations. This provides flexible control over the trade-off between accuracy and completeness, depending on the needs of downstream applications.

The global accumulator 190 receives, as input, the set of pairwise pointmaps 134 (from the reconstruction network 130) and the set of image connections 118 (from the scene graph construction module 180) and produces the globally aligned pointmaps 138 as output. In certain embodiments, the global accumulator 190 aligns each individual pairwise pointmap in the set of pairwise pointmaps 134 with a global coordinate system. In certain embodiments, the global alignment of the pairwise pointmaps in the set of pairwise pointmaps is performed by traversing the pairwise pointmaps 134 based on the image connections in the set of image connections 118. As such, the system 100 provides, as output, globally aligned 3D representations (i.e., the globally aligned pointmaps 138) of the scene captured by the set of images 102.

FIG. 1B illustrates a system architecture 140 for an SfM system for generating, based on a set of input images, a globally-aligned 3D pointmap, in accordance with one or more embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories.

The system architecture 140 includes an encoder 150, a latent global alignment network 160, a decoder 170, a global accumulator 190, and a scene graph construction module 180. The encoder 150 receives input images (e.g., corresponding to the set of images 102 of FIG. 1A) and produces initial image tokens (e.g., corresponding to the image tokens 114 of FIG. 1A). With these initial image tokens, the system architecture 140 uses the latent global alignment network 160 to produce aligned image tokens (e.g., corresponding to the aligned image tokens 124 of FIG. 1A), and uses the scene graph construction module 180 to produce a scene graph 182 representing relationships between the input images (e.g., corresponding to the set of image connections 118). As illustrated in FIG. 1B, the scene graph 182 is a shortest-path tree (SPT). Using the scene graph 182, the system architecture 140 decodes subsets of the aligned image tokens using the decoder 170 and performs global accumulation using the global accumulator 190. After performing global accumulation of the pairwise pointmaps 172 output by the decoder 170, the system architecture 140 outputs globally aligned pointmaps 178 corresponding to all input images.

The input images, i.e., images 142-148, may be a set of unordered images or an ordered sequence of images. The input images are denoted as

$${\{ {I}_{i} \}}_{i = 1}^{N} ,$$

where Iᵢ∈ [symbol] , N is the number of images, H×W×3 defines the dimensions of each image, with height (H) of the image in pixels, width (W) of the image in pixels, and three color channels (e.g., Red-Green-Blue or RGB). The system architecture 140 reconstructs, for each image, camera extrinsics with six degrees of freedom (DoF), denoted as Pᵢ∈ [symbol] and camera intrinsics denoted as Kᵢ. The system architecture 140 further reconstructs, for each input image, a global 3D representation (i.e., a dense, globally-aligned 3D pointmap 178) at the image resolution, denoted as X∈ [symbol] The final dimension “3” of the pointmap represents the three coordinates (x, y, z) of each 3D point. The dense 3D pointmap 178 represents the scene geometry observed by the input images 142-148.

Encoder 150 extracts a set of initial feature tokens (denoted as “Image tokens 0”) for each input image. The feature tokens are also be referred to image tokens. In FIG. 1B, the input image 142 is encoded into the set of initial image tokens 152, the input image 144 into the set of initial image tokens 154, the input image 146 into the set of initial image tokens 156, and so on.

In certain embodiments, the encoder 150 divides each input image into a plurality of patches based on a predefined patch size (e.g., in pixels), and generates a corresponding image token for each image patch. The encoding is expressed as:

$${F}_{i}^{( 0 )} = Enc ( {I}_{i} ) , {F}_{i}^{( 0 )} ∈ {ℝ}^{⌊ \frac{H}{p} ⌋ \times ⌊ \frac{W}{p} ⌋ \times d} , \qquad ( Eq . 1 )$$

where p is the patch size of the encoder and d is the token dimensionality. The superscript (0) corresponds to the stage of latent global alignment. The superscript (0) indicates that

$${F}_{i}^{( 0 )}$$

is the input to the first level (“Block 1”) of the latent global alignment. More generally,

$${F}_{i}^{( l - 1 )}$$

represents the input to the l-th level (or stage) of the latent global alignment network 160, where l∈(1, L) and L is a non-negative integer.

The latent global alignment network 160 includes L number of blocks 158. The blocks 158, denoted as “Block 1,” . . . , “Block L,” are arranged sequentially. Each block 158 is referred to as a level of (or stage) of the latent global alignment network 160. For each level l∈(1, L), the respective block 158 receives the image tokens

$${F}_{i}^{( l - 1 )}$$

for each image and produces the augmented image tokens

$${F}_{i}^{( l )} .$$

The L blocks 158 facilitate information exchange among all image tokens in the feature space and ultimately output the aligned image tokens (denoted as “Image tokens L”). In FIG. 1B, the image tokens 162, 164, and 166 correspond to updated (or augmented) versions of the initial image tokens 152, 154, and 156, respectively.

The blocks 158 employ a scalable attention mechanism that facilitates information exchange among the image tokens. In certain embodiments, one or more (e.g., each) block 158 of the global alignment network 160 has the architecture of the latent global alignment block 158A of FIG. 1C. In certain embodiments, rather than operating directly on all image tokens, a smaller set of tokens is defined and used for this task. In one or more embodiments, a global token (denoted as gᵢ, where i=1, . . . , N for N input images) is determined for the set of image tokens corresponding to each input image. The global tokens are used to share information across the images, for example, through self-attention. The aggregated information is then propagated to the image tokens, for example, via cross-attention in a feed-forward manner, thereby enabling each image token to incorporate contextual information from other images.

FIG. 1C illustrates an example network architecture of a latent global alignment block 158A, in accordance with one or more embodiments. The block 158A may correspond to any of Block 0 through Block L within global alignment network 160. Block 158A receives, for each image, a set of local image tokens and a global token, either from a previous block or initialized based on the initial image tokens (“Image tokens 0”) output from the encoder 150. Block 158A outputs, for each image, a set of updated local image tokens and an updated global token.

Block 158A includes a self-attention layer 210 and a cross-attention layer 220, and may further include additional layers, such as normalization layers or residual connections. The self-attention layer 210 processes a set of global tokens 208 and outputs a set of updated global tokens 218. As discussed above, each global token corresponds to a single input image. In FIG. 1C, the input global token 202 and the updated global token 212 correspond to the initial image tokens 152 associated with the input image 142. Similarly, the input global token 204 and the updated global token 214 correspond to the input image 144, and the input global token 206 and the updated global token 216 correspond to the input image 146.

In certain embodiments, for each set of local image tokens

$$( {F}_{i}^{( 0 )} ) ,$$

a global token is computed, which is denoted as

$${g}_{i}^{( 0 )}$$

∈R^{d}, where d is the token dimensionality. The global token may be computed by averaging the image tokens along their spatial dimensions. For example, the initial image tokens 152, 154, and 156 can be aggregated via average pooling to initialize the global tokens 202, 204, and 206, respectively, for the block 158A corresponding to the first level of latent global alignment network 160.

For each level l∈(1, L), the information sharing across all global tokens

$${\{ {g}_{i}^{( l - 1 )} \}}_{i = 1}^{N}$$

using self-attention 210 is formulated as:

$${\{ {g}_{i}^{( l )} \}}_{i = 1}^{N} = Self ( {\{ {g}_{i}^{( l - 1 )} \}}_{i = 1}^{N} ) . \qquad ( Eq . 2 )$$

In certain embodiments, the scene graph 182 is provided to the block 158A, for example, as a conditional signal, to guide the global information sharing (e.g., among the global tokens 208 through the self-attention layer 210).

Then, the updated global information is propagated to the local image tokens

$${\{ {F}_{i}^{( l - 1 )} \}}_{i = 1}^{N}$$

for each image independently via cross-attention layer 220, formulated as:

$${F}_{i}^{( l )} = Cross ( {F}_{i}^{( l - 1 )} , {\{ {g}_{i}^{( l )} \}}_{i = 1}^{N} ) , \qquad ( Eq . 3 )$$

where

$${F}_{i}^{( l )}$$

represent the image tokens 200 output from the block 158A at the l-th level. This way, the set of updated global tokens are used to incorporate information into the local image tokens for each input image through cross-attention 220.

In certain embodiments, the output of the last block 158A within the latent global alignment network 160 passes through a residual connection to obtain the globally aligned image tokens, such as the “Image tokens L” including the aligned image tokens 162, 164, and 166 shown in FIG. 1B. For example, the aligned image tokens are denoted as Fᵢ, which are obtained by:

$${F}_{i} := {F}_{i}^{( 0 )} + {F}_{i}^{( L )} .$$

A naive implementation through self-attention over all image tokens requires a computation complexity expressed as [symbol] ((N×T)²), where N represents the number of images in the set (or batch), and T represents the number of tokens per image (e.g., the number of patches each image is divided into). This becomes prohibitive for large image sets. In contrast, the latent global alignment network 160 is able to achieve a time complexity of [symbol] (N²+N×T), where T=└H/p┘×└W/p┘. Although both are in the same asymptotic class for practical values of N and T, reducing the constant factor for practical values of N≈T makes the network significantly more efficient and enables scaling to larger image collections.

Referring back to FIG. 1B, the scene graph construction module 180 constructs the scene graph 182, based on the initial image tokens, i.e., 152, 154, 156, etc., to provide a structure that represents relationships between the various input images, i.e., 142, 144, 146, 148, etc. In FIG. 1B, the scene graph 182 is represented in a connected tree structure (specifically, a shortest path tree (SPT)), where each input image corresponds to a node, and the connections between images are represented as directed edges (arrows) indicating the spatial relationships among the images. For example, arrow 184 represents a connection from input image 144 to input image 146, arrow 186 represents a connection from input image 142 to input image 146, and arrow 188 represents a connection from input image 148 to input image 142. The input image 146 corresponds to the root node of the tree. For the N input images, the tree includes N−1 edges to connect all of the input images.

In certain embodiments, the scene graph construction module 180 leverages the encoder embeddings (e.g., the initial image tokens 152, 154, 156, etc.) to compute pairwise similarities between the input images. This allows filtering of irrelevant image pairs, such as those with low visual overlap. When a fully connected scene graph is used, decoding 3D pointmaps for every possible image pair can create a substantial computational bottleneck. By filtering out irrelevant or low-overlap image pairs, the scene graph is reduced to only the relevant connections between images, thereby avoiding unnecessary computation and improving overall efficiency.

In certain embodiments, average pooling is performed on the set of initial image tokens

$$( {F}_{i}^{( 0 )} )$$

of each image to obtain a one-dimensional (1D) embedding (F̅ᵢ). Then, a similarity matrix(S) is computed, which contains pairwise cosine similarities as:

$${S}_{i , j} = < {‖ {\overline{F}}_{i} ‖}_{2} , {‖ \overline{{F}_{j}} ‖}_{2} > , \qquad ( Eq . 4 )$$

where <·,·> denotes the scalar product. The 1D embedding (F̅ᵢ) is also used to initialize the corresponding global token.

In FIG. 1B, the scene graph 182 is an SPT constructed using the SPT algorithm, where the SPT edges are expressed as: E_{SPT}={(i, j)}. In a tree, such as a SPT, the cost of a path or edge represents a numerical value associated with traversing that edge, such as distance, time, or weight. The cost of a path from the root to a node is the sum of the costs of the edges along that path. The SPT edges connect all input images (as nodes in the SPT tree), while minimizing the cost of the paths towards each node. Intuitively, this leads to a flatter tree which only runs deep when it benefits the overall reconstruction. The root node for the SPT tree may be set as the one with lowest total cost with regard to all other nodes, for example, based on argminⱼΣᵢ−Sᵢⱼ. For example, the root node may correspond to the input image 146. The number of edges in a tree is linear in the number of images N, for example, |E_{SPT}|=N−1, leading to significantly better scalability than a fully-connected graph.

However, it will be noted that, in various embodiments, the scene graph 182 may be constructed using other suitable algorithms, such as a minimum spanning tree (MST) algorithm. In some embodiments, the scene graph construction module 180 can use alternative and/or additional image tokens to construct the scene graph 182. For example, updated image tokens output from one or more latent global alignment blocks 158 may be used.

The decoding step, performed by the decoder 170, converts image pairs connected by an edge in the scene graph 182 to pointmaps. For example, as indicated by the dashed line, the decoder 170 decodes the aligned image tokens 164 and 166 for the edge 184 to generate (or predict) a pair of pointmaps 172 (i.e., a pairwise pointmap). Similarly, the decoder 170 generates pairwise pointmaps by traversing all edges in the scene graph 182. In various embodiments, the decoder 170 may be a stereo reconstruction decoder or any other suitable type of decoder.

In at least one embodiment, the decoder 170 and/or encoder 150 uses a pretrained backbone, such as the Dense and Unconstrained Stereo 3D Reconstruction (DUSt3R) model (as detailed in Wang, et al., Dust3r: Geometric 3d vision made easy, in Proceedings of the IEEE/CVF Conference on Computer Vision and Pattern Recognition, 2024, which is incorporated by reference herein) or the Matching And Stereo 3D Reconstruction model (MASt3R) (as detailed in Leroy, et al., Grounding image matching in 3d with mast3r, in European Conference on Computer Vision, 2024, which is incorporated by reference herein). In another embodiment, the decoder 170 and/or encoder 150 is initialized with the Distillation of knowledge with NO labels, version 2 (DINOv2) model (as described in Oquab, et al., DINOv2: Learning robust visual features without supervision, in arXiv preprint arXiv: 2304.07193, 2023, which is incorporated by reference herein). In yet another embodiment, the decoder 170 and/or encoder 150 is initialized with the Segment Anything Model (SAM) (as detailed in Kirillov, et al., Segment anything, in Int. Conf. Comput. Vis., 2023, which is incorporated by reference herein) or the SAMv2 model (as detailed in Ravi, et al., Sam 2: Segment anything in images and videos, arXiv preprint arXiv: 2408.00714, 2024, which is incorporated by reference herein).

In certain embodiments, for every edge, (i, j)∈E_{SPT}, in the scene graph 182, the decoder 170 outputs two pointmaps and associated confidence maps defined as:

$$( {X}^{i , i} , {X}^{j , i} ) , ( {C}^{i , i} , {C}^{j , i} ) = D e c ( {F}_{i} , {F}_{j} ) . \qquad ( Eq . 5 )$$

Here X^{i,i}∈ [symbol] is the pointmap of the i-th input image and X^{j,i}∈ [symbol] is the pointmap of the j-th input image, both in the coordinate frame of the i-th input image. C^{j,i}, C^{i,i}∈ [symbol] are the confidence maps consisting of per-point confidence scores for each pointmap, respectively. After traversing all edges, the decoder 170 outputs the pairwise pointmaps for every edge, (i, j)∈E_{SPT}, with each pair aligned to its respective coordinate frame.

In certain embodiments, the input features (e.g., a paired set of aligned image tokens corresponding to an edge of the scene graph 182) to the decoder 170 are conditioned on all input images, which facilitates the generation of globally aligned pairwise pointmaps 172.

The global accumulator 190 performs global accumulation to aggregate (or accumulate) the pairwise pointmaps 172 by traversing all edges of the scene graph 182, resulting in the globally aligned pointmaps 178. This approach achieves reconstruction without requiring global optimization.

In certain embodiments, the pairwise pointmaps are combined into the global reconstruction, X∈ [symbol] , with the per-point confidences C. The sequence of combinations may be guided by traversing the edges (E_{SPT}) of the SPT in a breadth-first order, starting from the root of the tree. For the first edge, the global point reconstruction (e.g., a global point cloud) is initialized as X={Xⁱ, X^{j}} and C={Cⁱ, C^{j}}, where Xⁱ:=X^{i,i} and X^{j}:=X^{j,i} are the pointmaps for the edge in the coordinate system of the i-th input image, and Cⁱ, C^{j} are their corresponding confidence maps. As such, the i-th camera (corresponding to the i-th input image) is implicitly designated as the canonical coordinate frame for the global reconstruction, so that all reconstructed pointmaps and camera poses are expressed relative to this frame. Subsequently, the remaining local reconstructions predicted from the consecutive edges can be registered to this initial global reconstruction. For example, the pairwise pointmaps 172 corresponding to the subsequent edges are aligned to the already registered pointmaps 174, resulting in the aligned pairwise pointmaps 176. As indicated by the dashed arrow, the aligned pairwise pointmaps 176 may be stored as the registered pointmaps 174 for subsequently accumulation. The final output of the global accumulator 190 includes the globally aligned pointmaps 178 corresponding to all input images. Based on the traversal order, node k of the next edge (k, l) has already obtained its global registered pointmap X^{k}∈X in the previous step. The confidence map of node k is updated to: C^{k}:=C^{k}⊙C^{k,k}, where (denotes the element-wise geometric mean. The update of the confidence map takes into consideration the confidence of the pointmap prediction C^{k,k} given the current pair. To register node l to the global reconstruction, the optimal rigid body transformation between the two pointmaps, denoted as X^{k} (in the global coordinate) and X^{k,k} (in the same coordinate system of node l), is estimated via Procrustes alignment as:

$${P}_{k} = Procrustes ( {X}^{k} , {X}^{k , k} , log {C}^{k} ) , \qquad ( Eq . 6 )$$

where log C^{k}∈[0, ∞]^{H×W} serves as a per-point weight. Then, the pointmap of node l is transformed into the global coordinate frame by:

$${X}^{l} = {P}_{k}^{- 1} {X}^{k , l} . \qquad ( Eq . 7 )$$

The pointmap of node l is added to the global reconstruction as: X:=X∪{X^{l}}. These operations are repeated for all edges in E_{SPT}. As such, the per-image globally registered pointmaps (Xⁱ) with the associated confidence maps Cⁱ are obtained, and can be used to generate the aggregated global reconstruction (X).

FIG. 2 illustrates a flowchart of a method 230 for training a model to generate, based on a set of input images, a globally-aligned 3D pointmap, in accordance with one or more embodiments. Each block of method 230, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API), or a plug-in to another product, to name a few. In addition, method 230 is described, by way of example, with respect to the system architecture 140 of FIG. 1B. However, this method may additionally or alternatively be executed by any one system, or any combination of systems, including, but not limited to, those described herein. Furthermore, persons of ordinary skill in the art will understand that any system that performs method 230 is within the scope and spirit of embodiments of the present disclosure.

In this example, the model implements the system architecture 140 of FIG. 1B. In certain embodiments, the encoder (or encoders) 150 is a pre-trained or readily available off-the-shelf encoder model. Training is performed to update (or tune) the learnable parameters in the latent global alignment network 160 (e.g., the latent global alignment blocks 158) and the decoder 170.

At block 232, the model receives a training sample including a set of images and a corresponding set of ground-truth pointmaps, corresponding ground truth valid pixels for each ground-truth pointmap, and ground-truth camera poses. The training sample may be selected from a training dataset. In certain embodiments, the ground-truth pointmaps are provided in a world coordinate frame (e.g., corresponding to a global coordinate system). The ground-truth camera poses (e.g., providing camera intrinsics and extrinsics) can be used to convert the world coordinate system into individual frame coordinate systems. The 3D points in the ground-truth pointmaps correspond to valid pixels in the input images.

At block 234, the model predicts pairwise pointmaps for image pairs from the set of images. The model encodes the set of images into initial image tokens, enhances the image tokens using the latent global alignment network 160, and decodes the enhanced image tokens into pairwise pointmaps 172, guided by the scene graph 182 provided by the scene graph construction module 180.

At block 236, the model predicts a globally aligned pointmap for all images from the set of images, where the globally aligned pointmap is provided as a set of aligned pairwise predicted pointmaps X={X¹, . . . , X^{N}}. The model uses the global accumulator 190 to register the predicted pairwise pointmaps to the global coordinate system, guided by the scene graph 182, thereby producing the globally aligned pointmaps 178.

Method 230 implements a supervised scheme, which jointly supervises both the pairwise local pointmaps (e.g., the pairwise pointmaps 172 output from the decoder 170) and the globally aligned pointmaps (e.g., the globally aligned pointmaps 178).

At block 238, a first loss is computed based on differences between the predicted pairwise pointmaps (generated at 234) and the ground-truth pointmaps adjusted to the frame coordinates. This is referred to as pairwise supervision. The first loss is denoted as [symbol] ₚₐᵢᵣ. In certain embodiments, a set of ground-truth pointmaps in the world coordinate frame is denoted as

$$\overline{X} = {\{ {\overline{X}}^{i} \}}_{i = 1}^{N} .$$

The ground-truth valid pixels are denoted as

$${P}_{{i}_{i = 1}}^{N} .$$

The ground-truth camera poses are denoted as

$${\{ {𝒟}^{i} \}}_{i = 1}^{N} .$$

The first loss is computed as:

$${ℒ}_{p a i r} = {\sum }_{( i , j ) ∈ {E}_{S P T}} ( {ℒ}_{c o n f} ( {P}_{i} {\overline{X}}^{i} , {X}^{i , i} , {C}^{i , i} , {𝒟}^{i} ) + {ℒ}_{c o n f} ( {P}_{i} {\overline{X}}^{j} , {X}^{j , i} , {C}^{j , i} , {𝒟}^{j} ) ) , \qquad ( Eq . 8 )$$

$${ℒ}_{c o n f} ( \overline{X} , X , C , 𝒟 ) := {\sum }_{p ∈ 𝒟} {C}_{p} ‖ {X}_{p} - {\overline{X}}_{p} ‖ - α {C}_{p} , \qquad ( Eq . 9 )$$

where X, C, X̅ are the predicted pairwise pointmap, a confidence map, and the ground-truth pointmap, respectively, [symbol] ⊆{1 . . . W}×{1 . . . H} defines the valid pixels, and α>0 regularizes the confidences to not be pushed to zero. PᵢX̅ⁱ and PᵢX̅^{j} convert the world coordinate frame into the coordinate frame of the i-th image for the i-th and j-th images, respectively.

At block 240, a second loss is computed based on differences between the predicted globally aligned pointmap and the ground-truth pointmap. This is referred to as global supervision. The second loss is denoted as [symbol] _{global}. To compute the second loss, the set of predicted pointmaps X={X¹, . . . , X^{N}}, which are defined with regard to the root node of the SPT, are aligned to the ground-truth pointmaps via a rigid body transformation provided by:

$${P}_{a l i g n} = Procrustes ( \overline{X} , X ) . \qquad ( Eq . 10 )$$

Then, the transformed global pointmap prediction for each image is evaluated by:

$${ℒ}_{g l o b a l} = {\sum }_{i ∈ \{ 1 , … N \}} {ℒ}_{c o n f} ( {\overline{X}}^{i} , {P}_{a l i g n} {X}^{i} , {C}^{i} , {𝒟}^{i} ) . \qquad ( Eq . 11 )$$

The second loss (e.g., the global loss) implicitly supervises the inaccuracy of the poses extracted from the globally aligned pointmap, since inaccurate poses from the pairwise Procrustes alignment leads to a higher global loss.

At block 242, parameters of the model are updated based on a composite loss that combines the first and second losses computed at blocks 238 and 240. In certain embodiments, The composite loss is defined as:

$$ℒ = {ℒ}_{p a i r} + {λℒ}_{g l o b a l} , \qquad ( Eq . 12 )$$

where λ is a hyperparameter that weights the relative contribution of the first and second losses to the combined loss (in certain embodiments, the hyperparameter is set to 0.1 to more heavily weight the contribution of the first loss).

At block 244, method 230 determines whether training is complete (e.g., by determining whether additional samples remain in the proxy dataset or by considering alternative termination criteria). If training is not complete, method 230 loops back to step 232 to select another training sample. Alternatively, if training is complete, method 230 proceeds to block 246, where the learnable parameters of the model (i.e., the learnable parameters of the latent global alignment block(s) 158 in the latent global alignment network 160 and the parameters of the decoder 170) are output. When multiple latent global alignment blocks 158 are employed, these blocks share the same model architecture (e.g., as illustrated in FIG. 1C).

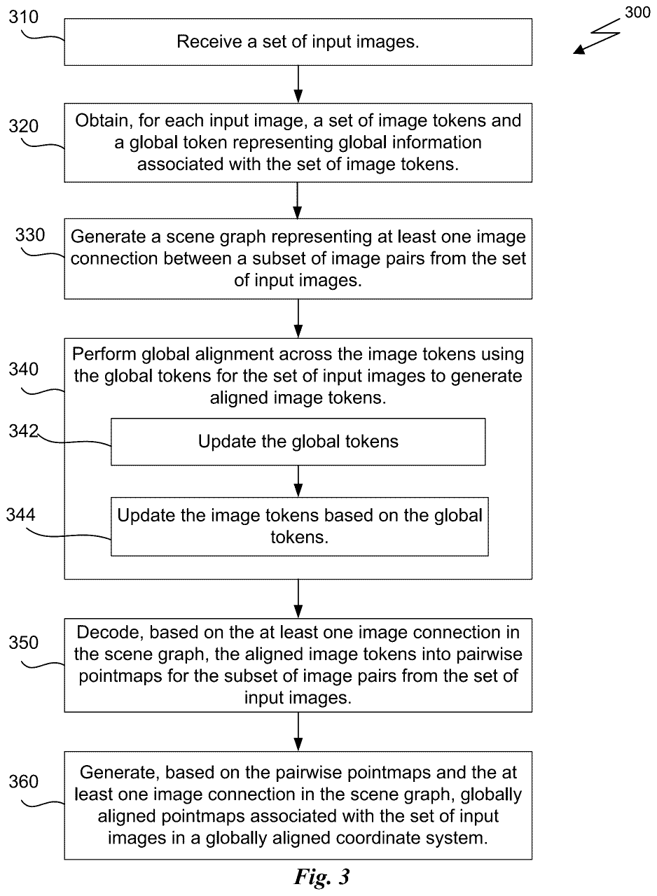

FIG. 3 illustrates a flowchart of a method 300 for generating, via a model including one or more neural networks and based on a set of input images, a globally-aligned 3D pointmap, in accordance with one or more embodiments. Each block of method 300, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API), or a plug-in to another product, to name a few. In addition, method 300 is described, by way of example, with respect to a system of FIG. 1A or a model implementing the system architecture 140 of FIG. 1B. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

In certain embodiments, the model is obtained through training by performing method 230. During inference, the model performs the method 300.

At block 310, the model receives a set of input images.

At block 320, the model obtains, for each input image, a set of image tokens and a global token representing global information associated with the set of image tokens. For example, as shown in FIGS. 1B and 1C, the system encodes the input image 142 into the set of (initial) image tokens 152 and obtains a corresponding global token 202.

At block 330, the model generates a scene graph representing at least one image connection between a subset of image pairs from the set of input images. For example, the scene graph consists of nodes connected by at least one edge, where each node represents an input image from the set of input images, and each edge represents a connection between a pair of images from the set input images.

At block 340, the model performs global alignment across the image tokens using the global tokens for the set of input images to generate aligned image tokens.

Specifically, at block 342, the model updates the global tokens corresponding to the set of input images. The global tokens are updated through at least one latent global alignment block 158. For example, in each latent global alignment block 158, the self-attention layer 210 processes global tokens 208 and outputs updated global tokens 218.

At block 344, the model updates, based on the updated global tokens, the image tokens corresponding to the set of input images. The image tokens are also updated through the at least one latent global alignment block 158. For example, in each latent global alignment block 158, the updated global tokens 218 are used to update the image tokens through the cross-attention layer 220. The last latent global alignment block 158 outputs the aligned image tokens.

At block 350, the model decodes, based on the at least one image connection in the graph scene, the aligned image tokens into pairwise pointmaps for the subset of image pairs from the set of input images. For example, the model performs the decoding by traversing all edges in the scene graph.

At block 360, the model generates, based on the pairwise pointmaps and the at least one image connection in the graph scene, a globally aligned pointmap associated with the set of input images in a globally aligned coordinate system. For example, the model accumulates the pairwise pointmaps by traversing all edges in the scene graph.

The feed-forward SfM model disclosed herein enables robust, accurate, and efficient structure-from-motion in the wild, making it well-suited for large-scale real-world applications. The feed-forward SfM model performs reconstruction on image pairs and scales efficiently to large image collections using a global latent alignment module, which aligns pairwise predictions in latent space and eliminates the need for global optimization. The model also leverages a sparse scene graph, preserving only relevant correspondences between images to reduce memory usage. By combining (i) globally aligned image tokens—implicitly aligned feature tokens sharing global information across images prior to pairwise 3D reconstruction—with (ii) the sparse scene graph, the feed-forward SfM model avoids exhaustive, brute-force merging of pairwise pointmaps and iterative optimization typical of prior techniques, substantially reducing runtime and memory requirements while maintaining competitive accuracy.

Systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

In some examples, the model(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs, e.g., REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Systems and methods described herein can be utilized or performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of underlying algorithms, systems, image processing pipelines, and/or processes prior to deploying them in the real-world. In some instances, the simulation may be used to generate synthetic training data (e.g., training data including landmarks, features, objects, etc.). so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms-such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

More illustrative information will now be set forth regarding various optional architectures and features with which one or more embodiments may be implemented, per the desires of the user. It should be strongly noted that the following information is set forth for illustrative purposes and should not be construed as limiting in any manner. Any of the following architectures and features may be optionally incorporated with or without the other architectures and features described.

### Parallel Processing Architecture

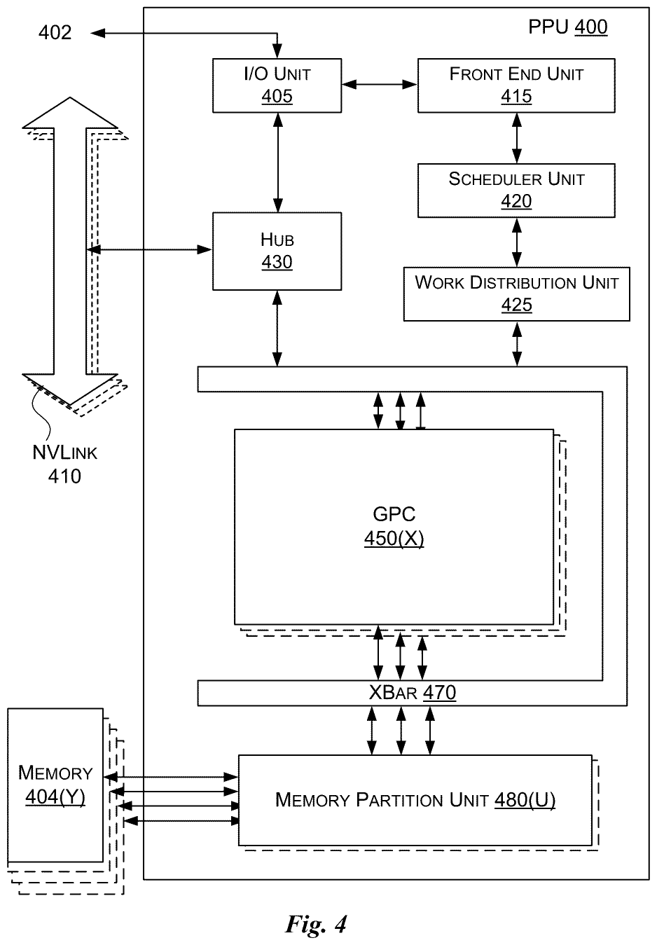

FIG. 4 illustrates a parallel processing unit (“PPU”) 400, according to at least one embodiment. The PPU 400 may be used as a component of one or more embodiments of one or more systems disclosed herein or may be used to implement one or more embodiments of one or more methods disclosed herein. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one example parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

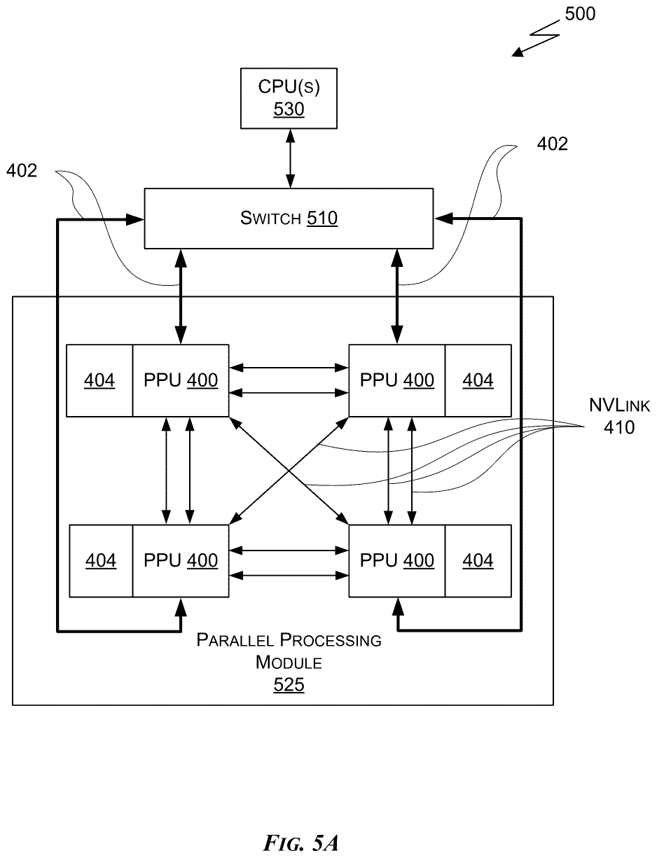

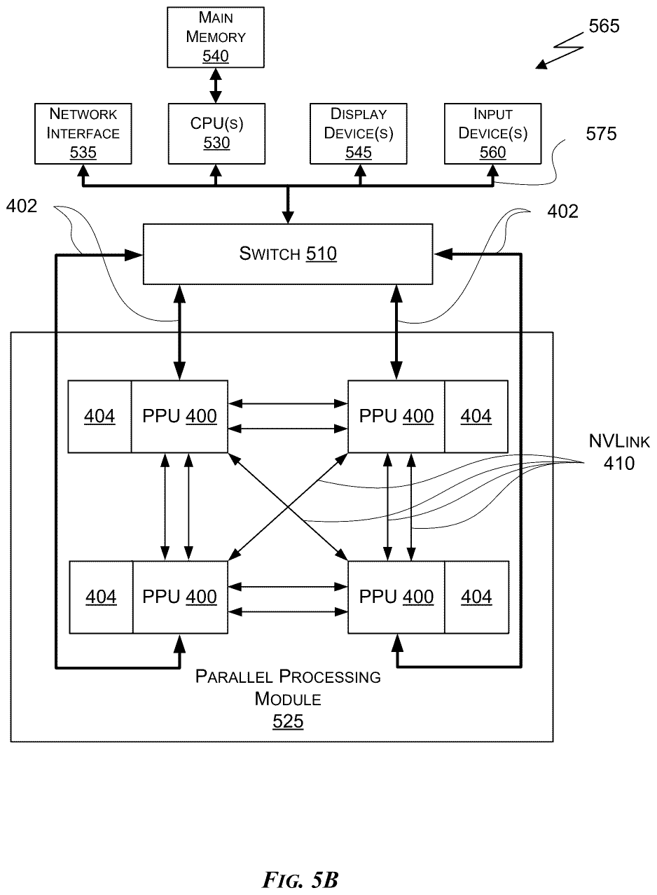

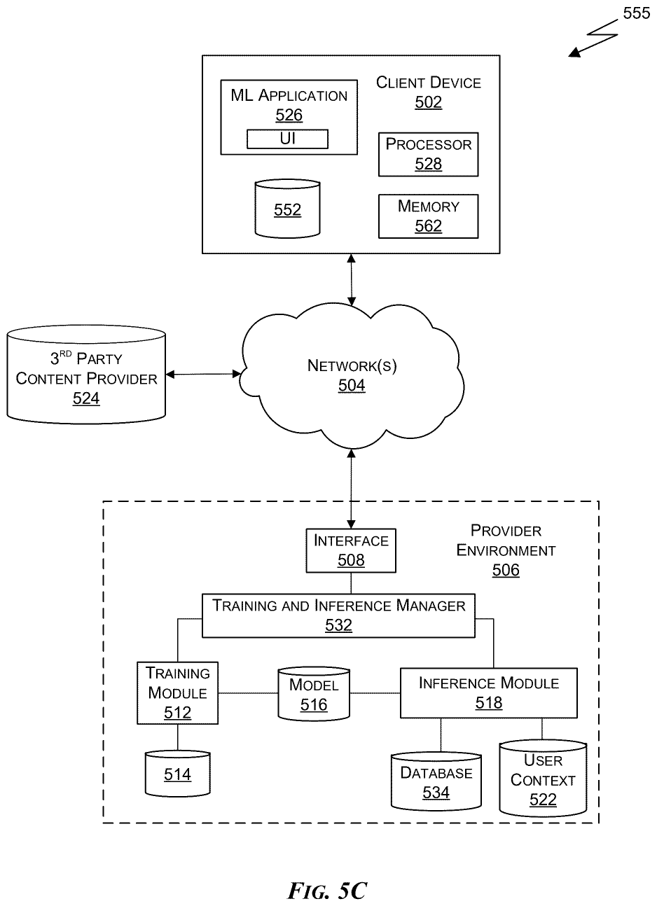

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A illustrates a processing system 500 implemented using the PPU 400 of FIG. 4, according to at least one embodiment. The example system 500 may be used as a component of one or more embodiments of one or more systems disclosed herein or may be used to implement one or more embodiments of one or more systems and methods disclosed herein. The processing system 500 includes a CPU 530, switch 510, and multiple PPUs 400, and respective memories 404. The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an example system 565 in which the various architecture and/or functionality of the various previous embodiments may be implemented, according to at least one embodiment. The example system 565 may be used as a component of one or more embodiments of one or more systems disclosed herein or may be used to implement one or more embodiments of one or more systems and methods disclosed herein. As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or example system 565 of FIG. 5B—e.g., each device may include similar components, features, and/or functionality of the processing system 500 and/or example system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or example system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates an example system 555 that can be used to train a machine learning model, according to at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

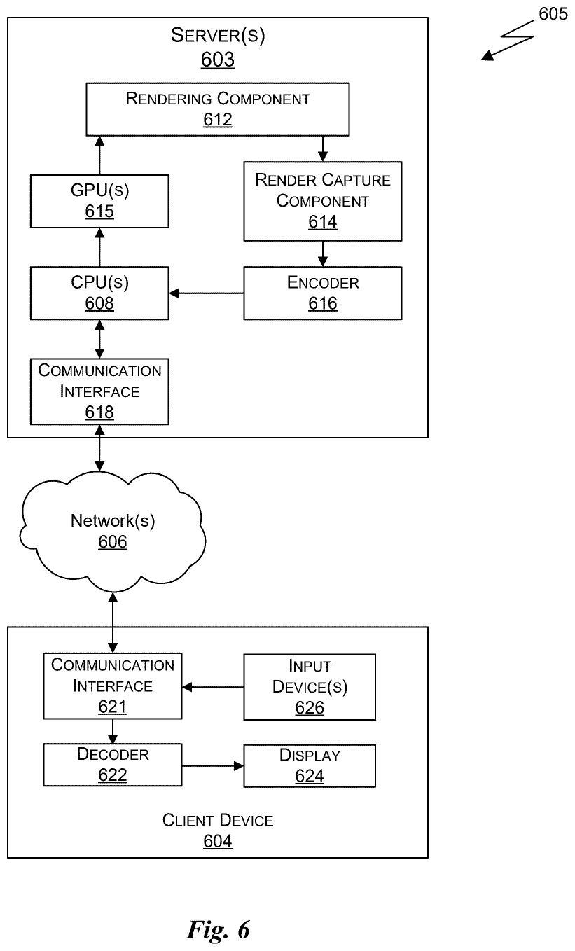

FIG. 6 illustrates an example streaming system 605, according to at least one embodiment. FIG. 6 includes server(s) 603 (which may include similar components, features, and/or functionality to the example processing system 500 of FIG. 5A and/or example system 565 of FIG. 5B), client device(s) 604 (which may include similar components, features, and/or functionality to the example processing system 500 of FIG. 5A and/or example system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

One or more embodiments of the disclosure may be described in the general context of computer code or machine-useable instructions, including computer-executable instructions such as program modules, being executed by a computer or other machine. Generally, program modules, e.g., including routines, programs, objects, components, data structures, etc., refer to code that performs particular tasks or implements particular data types. One or more embodiments of the disclosure may be practiced in a variety of system configurations, including, e.g., hand-held devices, consumer electronics, general-purpose computers, more specialty computing devices, etc. One or more embodiments of the disclosure may also be practiced in distributed computing environments where tasks are performed by remote-processing devices that are linked through a communications network.

Operations of processes described herein can be performed in any suitable order unless otherwise explicitly indicated herein or otherwise clearly contradicted by context. In at least one embodiment, a process, such as described herein (or variations and/or combinations thereof), is performed under control of one or more computer systems configured with executable instructions and is implemented as code (e.g., executable instructions, one or more computer programs, or one or more applications) executing collectively on one or more processors. In at least one embodiment, code is stored on computer-readable storage media, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, computer-readable storage media comprises multiple non-transitory computer-readable storage media, and one or more individual non-transitory storage media of the multiple non-transitory computer-readable storage media lack all code while the multiple non-transitory computer-readable storage media collectively store all of code. In at least one embodiment, executable instructions are executed such that different instructions are executed by different processors—for example, non-transitory computer-readable storage media store instructions and a main central processing unit (“CPU”) executes some of the instructions while a graphics processing unit (“GPU”) executes others of the instructions. In at least one embodiment, different components of a computer system have separate processors and different processors execute different subsets of instructions.

In at least one embodiment, as a result of processing an instruction retrieved by the processor, the processor presents one or more inputs or operands to an arithmetic logic unit (ALU), causing the ALU to produce a result based at least in part on an instruction code provided to inputs of the arithmetic logic unit. In at least one embodiment, the instruction codes provided by the processor to the ALU are based at least in part on the instruction executed by the processor. In at least one embodiment, combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term “arithmetic logic unit,” or “ALU,” may be used to refer to any computational logic circuit that processes operands to produce a result. For example, in the present document, the term ALU can refer to a floating point unit, a digital signal processor (DSP), a tensor core, a shader core, a coprocessor, or a CPU. In at least one embodiment, an ALU is a set of combinational logic circuitry that takes one or more inputs to produce a result. In at least one embodiment, an ALU is used by a processor to implement mathematical operation such as addition, subtraction, or multiplication. In at least one embodiment, an ALU is used to implement logical operations such as logical AND/OR or XOR. In at least one embodiment, an ALU is stateless, and made from physical switching components such as semiconductor transistors arranged to form logical gates. In at least one embodiment, an ALU may operate internally as a stateful logic circuit with an associated clock. In at least one embodiment, an ALU may be constructed as an asynchronous logic circuit with an internal state not maintained in an associated register set. In at least one embodiment, an ALU is used by a processor to combine operands stored in one or more registers of the processor and produce an output that can be stored by the processor in another register or a memory location.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as systems may embody one or more methods and methods may be considered a system.

Use of any and all examples, or exemplary language (e.g., “such as”) provided herein, is intended merely to better illuminate embodiments of the disclosure and does not pose a limitation on scope of disclosure unless otherwise explicitly stated. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but still co-operate or interact with each other.

Unless specifically stated otherwise, it may be appreciated that throughout the specification terms such as “processing,” “computing,” “calculating,” “determining,” or the like, refer to action and/or processes of a computer or computing system, or similar electronic computing device, that manipulate and/or transform data represented as physical, such as electronic, quantities within registers and/or memories into other data similarly represented as physical quantities within memories, registers or other such information storage, transmission, or display devices.

In the present the document, references may be made to obtaining, acquiring, receiving, or inputting analog or digital data into a subsystem, computer system, or computer-implemented machine. In at least one embodiment, processes of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances. In addition, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

Use of terms “a” and “an” and “the” and similar referents in context of describing disclosed embodiments (especially in context of the following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within a range, unless otherwise indicated herein, and each separate value is incorporated into the specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B or C,” unless specifically stated otherwise or otherwise clearly contradicted by context, is understood with context as used in general to present that an item, term, etc., may be either A or B or C, or any nonempty subset of set of A and B and C. For instance, in illustrative an example of a set having three members, conjunctive phrases “at least one of A, B, and C” and “at least one of A, B or C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more, e.g., when so indicated either explicitly or by context. Further, unless stated otherwise or otherwise clear from context, the phrase “based on” means “based at least in part on” and not “based solely on.”

The foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. For example, the phrase “based on” is intended to mean “based at least in part on” and not “based solely on.” No language in the specification should be construed as indicating any non-claimed element as essential to the practice of the invention as claimed.

What is claimed is:

1. A system, comprising:
one or more memories to store parameters corresponding to one or more neural networks; and
one or more processors to use one or more neural networks configured with the parameters to generate a set of image tokens based on a plurality of input images, process the set of image tokens using an alignment network to generate a set of aligned image tokens, generate a scene graph that represents image connections between two or more of the plurality of input images, decode subsets of the aligned image tokens based on the image connections to produce a plurality of pairwise point maps, and generate a plurality of 3D pointmaps representing the plurality of input images.

2. The system of claim 1, wherein the one or more processors are further to:
obtain a set of global tokens, each global taken representing global information associated with a subset of image tokens corresponding to an input image of the plurality of input images,
wherein the one or more processors process the set of image tokens to generate the set of aligned image tokens using the set of global tokens.

3. The system of claim 2, wherein the one or more processors are further to:
update the set of global tokens corresponding to the plurality of input images; and
update, based on the set of updated global tokens, the set of image tokens.

4. The system of claim 3, wherein the alignment network comprises one or more latent global alignment blocks, wherein a given latent global alignment block is configured to:
receive the set of image tokens and the set of global tokens;
obtain the set of updated global tokens by applying self-attention to the set of input global tokens; and
obtain the set of updated image tokens by updating each subset of image tokens corresponding to an input image using the set of updated global tokens through cross-attention.

5. The system of claim 4, wherein the one or more latent global alignment blocks comprise a first latent global alignment block and a second latent global alignment block,
wherein the set of global tokens received by the first latent global alignment block are initialized based on the set of image tokens produced by an encoder,
wherein the set of global tokens received by the second latent global alignment block are the set of updated global tokens output from the first latent global alignment block.

6. The system of claim 1, wherein each pairwise 3D pointmap of the plurality of pairwise 3D pointmaps is represented in a frame coordinate system corresponding to one frame of the respective input image pair.

7. The system of claim 6, wherein each image connection in the scene graph corresponds to an image pair from the plurality of input images, and
wherein the one or more processors decode the subsets of the aligned image tokens to produce the plurality of pairwise 3D pointmaps corresponding to the input image pairs by traversing the one or more image connections in the scene graph.

8. The system of claim 7, wherein the scene graph is generated by maximizing pairwise image similarities.

9. The system of claim 8 wherein the scene graph is represented by a shortest-path tree (SPT) comprising a plurality of nodes and one or more edges, wherein each node represents an input image of the plurality of input images, and each edge connects a pair of nodes.

10. The system of claim 1, wherein training the one or more neural networks comprises updating learnable parameters in the alignment network and updating learnable parameters in a decoder for decoding the subsets of the aligned image tokens to produce the plurality of pairwise 3D pointmaps corresponding to input image pairs, wherein training the one or more neural networks utilize supervision for pairwise local pointmaps and globally aligned pointmaps.

11. The system of claim 10, wherein the supervision for pairwise local pointmaps and globally aligned pointmaps is performed using one or more of ground-truth pointmaps, corresponding valid pixels, or ground-truth camera poses.

12. A method for performing three-dimensional (3D) scene reconstruction comprising:
generating, based on a plurality of input images, a set of image tokens;
processing, via an alignment network, the set of image tokens to generate a set of aligned image tokens;
generating a scene graph representing one or more image connections between the plurality of input images;
decoding, based on the one or more image connections, subsets of the aligned image tokens to produce a plurality of pairwise 3D pointmaps corresponding to input image pairs; and
generating, based on the plurality of pairwise pointmaps and the scene graph, a plurality of 3D pointmaps corresponding to the plurality of input images.

13. The method of claim 12, wherein the method is performed by at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or
a system that incorporates one or more machine learning models deployed in a service or microservice along with an OS-level virtualization package.

14. The method of claim 12, further comprising:
obtaining a set of global tokens, each global taken representing global information associated with a subset of image tokens corresponding to an input image of the plurality of input images,
wherein processing, via the alignment network, the set of image tokens to generate the set of aligned image tokens comprises processing the set of global tokens to generate the set of aligned image tokens.

15. The method of claim 14, further comprising:
updating the set of global tokens corresponding to the plurality of input images; and
updating, based on the set of updated global tokens, the set of image tokens.

16. The method of claim 15 wherein the alignment network comprises one or more latent global alignment blocks, wherein the method further comprises:
receiving, a given latent global alignment block, the set of image tokens and the set of global tokens;
obtaining, by given latent global alignment block, the set of updated global tokens by applying self-attention to the set of input global tokens; and
obtaining, by given latent global alignment block, the set of updated image tokens by updating each subset of image tokens corresponding to an input image using the set of updated global tokens through cross-attention.

17. The method of claim 16, wherein the one or more latent global alignment blocks comprise a first latent global alignment block and a second latent global alignment block,
wherein the set of global tokens fed to the first latent global alignment block are initialized based on the set of image tokens produced by an encoder,
wherein the set of global tokens fed to the second latent global alignment block are the set of updated global tokens output from the first latent global alignment block.

18. The method of claim 12, wherein each pairwise 3D pointmap of the plurality of pairwise 3D pointmaps is represented in a frame coordinate system corresponding to one frame of the respective input image pair,
wherein each image connection in the scene graph corresponds to an image pair from the plurality of input images, and
wherein decoding, based on the one or more image connections, the subsets of the aligned image tokens to produce the plurality of pairwise 3D pointmaps corresponding to the input image pairs is performed by traversing the one or more image connections in the scene graph.

19. One or more processors comprising:
circuitry to implement an application programming interface (API), which in response to an API call received through the API, one or more operations comprising:
an operation to receive a plurality of input images;
an operation to generate a set of image tokens based on the plurality of input images;
an operation to process, via an alignment network, the set of image tokens to generate a set of aligned image tokens;
an operation to generate a scene graph representing one or more image connections between the plurality of input images;
an operation to decode, based on the one or more image connections, subsets of the aligned image tokens to produce a plurality of pairwise 3D pointmaps corresponding to input image pairs; and
an operation to generate, based on the plurality of pairwise pointmaps and the scene graph, a plurality of 3D pointmaps corresponding to the plurality of input images.

20. The processor of claim 19, wherein the one or more operations further comprise:
an operation to obtain a set of global tokens, each global taken representing global information associated with a subset of image tokens corresponding to an input image of the plurality of input images,
wherein the operation to process, via the alignment network, the set of image tokens to generate the set of aligned image tokens comprises an operation to process the set of global tokens.
